(19) United States
(12) Patent Application Publication
(10) Pub. No.: US 2025/0211434 A1
(43) Pub. Date: Jun. 26, 2025

(54) Intelligent Biometric Authentication Using Secure Similarity and Dissimilarity Determination

(71) Applicants: Florian KERSCHBAUM, Waterloo (CA); John Abraham PREMKUMAR, Waterloo (CA)

(72) Inventors: Florian KERSCHBAUM, Waterloo (CA); John Abraham PREMKUMAR, Waterloo (CA)

(21) Appl. No.: 19/077,036

(22) Filed: Mar. 11, 2025

Related U.S. Application Data
(63) Continuation-in-part of application No. 18/070,738, filed on Nov. 29, 2022, now Pat. No. 12,255,987.
(60) Provisional application No. 63/284,294, filed on Nov. 30, 2021.

(51) Int. Cl. H04L 9/08

(52) U.S. Cl. CPC H04L 9/0866; H04L 9/085; H04L 9/0894

(57) ABSTRACT

According to a method for biometric authentication of a user of a client computing platform, a service-providing system inputs from the client computing platform a candidate vector comprising an encoded, ordered data set that is encrypted using a key generated from a secret entered by the user in the client computing platform. The ordered data set is a digital representation of at least one physical and/or behavioral biometric parameter of the user. Without requiring any knowledge of raw data about the secret or the biometric parameter(s), a comparison value is determined according to a comparison function between the candidate vector and a template vector stored in the service-providing system. When the comparison value meets a predetermined criterion, an authentication message is generated indicating sufficient similarity between the candidate and template vectors.

### CROSS REFERENCE TO RELATED APPLICATIONS

This application is a continuation-in-part of U.S. patent application Ser. No. 18/070,738, filed 29 Nov. 2022, which claims priority of U.S. Provisional Patent Application No, 63/284,294, filed 30 Nov. 2021. This application claims priority of both of these previous applications.

### TECHNICAL FIELD

This invention relates to digital authentication using machine learning.

### BACKGROUND OF THE INVENTION

Many common practical situations are not “binary”, identical/different, yes/no, 1/0, but rather display varying degrees of similarity. For example, different entities, such as different companies, different departments within a company or agency, might have respective copies of a data set that are in essence identical, but that differ by only a few words or metadata items, such that a strict binary comparison would indicate simply that they are not the same. As another example, two scans of the same finger or iris will in practice never indicate total digital bit-level identity. Similar issues arise in many other contexts as well, for example, data sets from different sources, personal identification information, texts up to a fixed length, computer/financial security/risk events, etc.

One disadvantage of many existing comparison schemes is that they reduce resolution (and hence implicitly security) to be able to provide a useful comparison at all. For example, assume that the coordinates of two versions of an identifier such as a physical signature, a fingerprint, a retinal or iris scan, etc., are measured with 16-bit precision. The probability that the data sets representing the identifiers will match bit-for-bit is infinitesimal. Most systems therefore consider corresponding point pairs to “match” if their difference lies in some range, which means that less than 16 bits of precision are actually used; it also means that it is more likely that a fake identifier will be accepted.

Yet another disadvantage of many existing methods is that they require or lead to leakage of information contained in the data sets being compared; this can be a serious drawback when the data sets include personal information.

In some situations, what is needed is a notion of similarity among the elements in compared data sets, such as in applications that identify similar events, for example biometric identification, entity resolution or record linkage. In some other situations, what is needed is implementation of a notion of dissimilarity of events, such as for intrusion or fraud detection.

Another situation in which similarity/dissimilarity comes into play is for different authentication methods used to determine a user's access right to computer hardware or software, including remote content. Most commonly, authentication involves nothing more than requiring a username and password. This is of course binary: either the password matches the one most recently stored in a database corresponding to the username, or it does not. This naturally then leads to concern about passwords being hacked or discovered through, for example, brute force attacks—the entropy of most passwords is relatively low.

Many system designers then try to incorporate non-binary biometric identifiers such as fingerprints, facial recognition, etc., but this then gets back to the above-mentioned problem of having to reduce resolution to achieve repeatability.

### BRIEF DESCRIPTION OF THE DRAWINGS

FIG. 1 illustrates a system for implementing similarity/dissimilarity detection.

FIGS. 2 and 3 are state diagrams that show the messages and states of a client and a service-providing system, respectively, according to one embodiment, during execution of a protocol for determining similarity/dissimilarity of events.

FIG. 4 depicts the main components of an authentication system that uses biometrics over encrypted data.

### DESCRIPTION OF THE INVENTION

In broadest terms, the invention provides a method and system implementation that enables comparison of representations of different events submitted to a server, for example by different entities (“clients”), or by a single client at different times, without necessarily having to reveal anything about the underlying “raw” data itself. Biometric information, which may include either or both of physical and behavioral biometric information, is included in the representation of an “event”, which is then analyzed by an authentication system and method.

As used here, an “event” is any data set, just a few examples of which are data at rest, such as stored files, data obtained from processing, data obtained by conversion of analog information or directly input in digital form from entities such as other computing systems, sensors, or even human users, etc. In other words, an “event” is anything—physical or logical—that can be represented in the form of a vector of elements, in which each element is a string of binary digits.

The data sets may represent the same thing, such as measurements of physical objects (for example, fingerprints, retinas or irises of eyes, images, etc.), but where the representations in digital form may in general not be identical, simply by the nature of the measurement process. The invention also comprises a method of coordination and communication between physical computing systems to carry out similarity or dissimilarity determination with at most negligible information leakage.

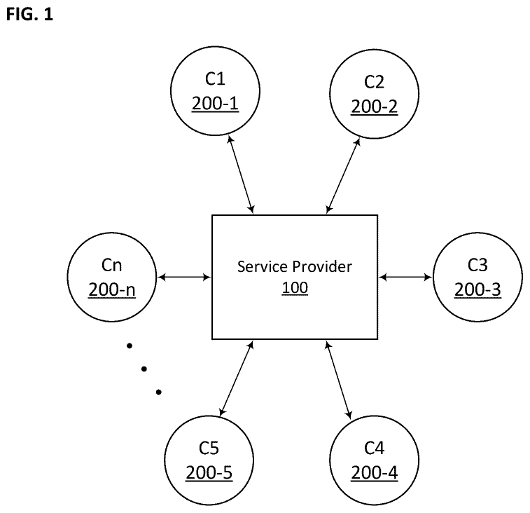

According to one feature of the invention, client systems Ci (see FIG. 1) first encode elements of data sets to be compared into fixed-length vectors of integers, which preserves similarity, that is, the vectors are considered similar if and only if their elements are similar. Such encodings already exist for several types of data, for example, text (BERT), database records (Record2vec), or names (Name2vec). Such encodings can also be trained for other types of data using machine learning. An autoencoder may then generate a latent representation of an input that is the required vector and comparable under a given distance metric, e.g., the L1 distance. If no encoding for the data type is available, one may instead train an autoencoder given the availability of sufficient training data.

After encoding the data the respective client encrypts it to protect its content from disclosure but in such a way that similarity over the encrypted data is preserved and comparison is enabled. To accomplish this, embodiments employ an approximate equality operator, which can then be used to build applications, such as for anomaly detection or record linkage. For anomaly detection, the invention-in particular, a server or “service provider” 100 (see FIG. 1)—first clusters the data elements based on approximate equality and then determines anomalies based on cluster features, such as cluster size. For record linkage, in one embodiment, the server looks for approximately equal data elements and outputs them as linked. Embodiments may use different similarity thresholds but still use approximate equality comparison at their core.

Embodiments may operate with two different types of entities, each of which may comprise more than one party/system. One entity type (a “client” 200) supplies encrypted data elements and the other entity type (the service provider 100) compares encrypted elements. The entity/-ies performing the comparison will learn the result of each comparison, i.e., whether two elements are similar or not, but nothing substantial beyond that. They may share this information with the parties supplying the encrypted elements, or only the result of additional analyses after those comparisons.

Embodiments use a novel, secure, approximate equality operator, which takes, as inputs, integer vectors \vec{x} and \vec{y}. The approximate equality operator first evaluates a similarity function (an inverse distance) s (\vec{x}, \vec{y}) between \vec{x} and \vec{y} and then compares s (\vec{x}, y) to a threshold t. If s(\vec{x}, \vec{y})≥t, then the operator outputs (approximately) “equal”; otherwise, it outputs “not equal”. A preferred relationship enabling determination of the threshold t, is described below.

The secure approximate equality operator reduces the information revealed about the vectors \vec{x} and \vec{y}. For an ideally secure operator, the party executing the operator should learn only the result, i.e., “equal” or “not equal”, but nothing else. This implies that the party executing the operator does not learn the plain vectors \vec{x} and \vec{y}, but rather only some transformed form of the vectors that the party cannot reverse. In one embodiment, the secure approximate equality operator works in a relaxed security model, where no information about \vec{x} and \vec{y} is revealed if the output is “not equal” but some information is revealed if the output is “equal”.

Two types of information may possibly be leaked: 1) more precise information about where two vectors are similar/dissimilar, for example, element indices where they are the same/differ, and 2) information about the encryption, which may, depending on the chosen encryption scheme, be used to recover information such as 1) about other vectors. This leakage can be contained, however, by re-keying the equality operator, that is, the parties choose a new key to use for subsequent vector pairs. This re-keying causes information such as 1) to be lost, but information 2) becomes useless. This embodiment has the advantage that it is much faster than known ideally secure operators.

### Formalization

Let λ be a security parameter that bounds a computational adversary, that is, λ is such that an adversary is not able to defeat the scheme given limited computational resources. The secure approximate equality operator consists of three, possibly probabilistic, polynomial-time operations:
K←KeyGen (1^{λ}): generates a (symmetric) key K using the security parameter λ.
\vec{c}←Encode (K; \vec{x}; t): generates a transformed ciphertext \vec{c} for vector \vec{x} and threshold t.
T/⊥←Compare (\vec{c}₁, \vec{c}₂): outputs “equal” (T) or “not equal” (⊥) given two transformed vectors \vec{c}₁ and \vec{c}₂.

A secure approximate equality operator is correct, if
∀λ, \vec{x}, \vec{y}, t
K←KeyGen (1^{λ})
\vec{c}₁←Encode (K, \vec{x}, t)
\vec{c}₂←Encode (K, \vec{y}, t)
Pr[s(\vec{x}, \vec{y})<Λ A Compare (\vec{c}₁, \vec{c}₂)=T]=neg1(λ)
Pr[s(\vec{x}, \vec{y})≥Λ Compare (\vec{c}₁, \vec{c}₂)=⊥]=neg1(λ)

In words, if the original vectors \vec{x}, \vec{y} are not sufficiently similar, then the likelihood that the comparison function Compare indicates that their encoded transformations are equal should be nil (the ideal case), or at most negligible (negl); conversely, if \vec{x} and \vec{y} are sufficiently similar, the probability that Compare indicates they are not should also be nil or at most negligible. In short, there should be at worst a negligible probability of a “false positive” or “false negative”. The acceptable probability of failure is determined by the parameter λ, which the system designer may choose according to the degree of probability of failure deemed acceptable in any given implementation of the invention.

Without loss of generality, one could formulate these statements with respect to distance instead of inverse distance, that is, set the threshold relative to similarity rather than dissimilarity. The term “similar” as used herein should therefore be taken to mean even “dissimilarity” inasmuch as the procedures to determine either are essentially the same, such that dissimilarity can be considered a form of “negative similarity”.

Let [symbol] (\vec{x}, \vec{y}) be the information about \vec{x} and \vec{y} leaked by executing the secure approximate equality operator and denote computational indistinguishability of two ensembles E₁ and E₂ as E₁ [symbol] E₂. We say an approximate equality operator is [symbol] -secure, if there exists a simulation function (a “simulator”) Sim( [symbol] (\vec{x}, \vec{y})) such that
∀ \vec{x}, \vec{y}, t
K←KeyGen (1^{λ})
\vec{c}₁←Encode(K, \vec{x}, t)
\vec{c}₂←Encode(K, \vec{y}, t)
Sim( [symbol] (\vec{x}, \vec{y})) [symbol] Compare (\vec{c}₁, \vec{c}₂)
   In words, the simulator Sim, which is a function of leakage [symbol] (\vec{x}, \vec{y}), which in turn is a function of the “raw” information in \vec{x}, \vec{y}, should produce the same output as Compare, which is a function of the encoded information in \vec{x}, \vec{y}, that is, of \vec{c}₁, \vec{c}₂. This implies that Compare cannot leak more information than the simulator Sim is given.

Let xᵢ be the i-th entry of vector \vec{x} and yᵢ be the i-th entry of vector \vec{y}. Let H_{K}_{ᵢ} (·) be a keyed, one-way transformation function, for example, a message authentication code (MAC). Let n be the length of vectors \vec{x} and \vec{y}. As used in one embodiment of the invention, an approximate equality operator is relaxed secure, for the specific leakage function [symbol] *:

$${ℒ}^{*} ( \vec{x} , \vec{y} ) = \{ \begin{matrix}[ T , i , {H}_{{K}_{i}} ( {x}_{i} ) , {H}_{{K}_{i}} ( {y}_{i} ) ] ∀ i \vert {x}_{i} \neq {y}_{i} & if s ( \vec{{x}_{i}} , \vec{{y}_{i}} ) > 2 t - n \\ ⊥ & otherwise\end{matrix}$$

[symbol] * thus returns at least four pieces of information in the case (and only in the case) two event vectors exceed the similarity threshold of 2t−n, namely, the “equality” indication T, as well as the indices of non-matching elements and the values of the transformation functions of non-matching vector element pairs. The indicators T/⊥ are the outputs as such, whereas the other values are inferable from the computation.

The leakage property reflects a tradeoff that leads to much greater efficiency than functional (inner-product predicate) encryption. What is leaked (not the output as such) is a part of the encryption key where the elements differ. The H( ) values are derived from the encryption key and, if they are available, for all i and xᵢ, they are sufficient to encrypt or decrypt an input. The keys are leaked if the input differs in some, but few (determined by the chosen threshold), indices i, such that they still are recognized as similar but not identical. If, however, there is insufficient information to determine similarity, then no information about the keys is leaked.

This “relaxed” leakage function [symbol] * has properties that differ from the “binary” leakage function [symbol] described above. First, [symbol] * provides information in addition to the solely binary T/⊥ information, but only in case of a match; otherwise, no additional information is revealed. More particularly, [symbol] * includes the two types of leakage information mentioned above in that i corresponds to leaked information type 1) and the rest of the expression corresponds to leaked information type 2). Second, in one specific instance of encoding/leakage, an attacker would be able to recover the leakage in case s>2t−n, but some methods that run in polynomial time, such as the known Berlekamp-Welch algorithm, would be able to recover the match only if s>t since they would need additional information, whereas the worst-case attack may require exponential time in n. Other polynomial-time algorithms, such as known list decoding methods, which, instead of outputting a single possible message, output a list of possibilities (in which “successful decoding” is when one of which is correct), may, however, under some circumstances, be able to recover a match for the case s>t′ where t′<t.

As is well known in the field of cryptography, a message authentication code (MAC) is a cryptographic function of input data that uses a session key to detect modifications of the data. The simplest version of a MAC takes two inputs: a message and a secret key and generates an output that is sometimes referred to as a “tag”. The MAC is non-invertible, that is one-way, meaning that one cannot determine the input message from the tag, even if one knows the secret key used in generating the tag. On the other hand, given the same inputs, a standard MAC is repeatable, that is, given the same inputs it will generate the same output. It is also collision resistant, meaning that it is computationally very difficult to find two dissimilar inputs that lead to the same MAC output. A verifier who also possesses the key can thus use it to detect changes to the content of the message in question. In most common uses of a MAC, the MAC routine itself generates the secret key for a message. In embodiments of the invention here, however, the clients 200 select the key to be used when transmitting their messages for comparison.

Let MAC_{K}(·) be a message authentication code using key K and denote the key generation function for the message authentication code MAC_{K}(·) as KeyGen_{MAC}.

To implement the encoding, embodiments may, for example, use linear error-correcting codes, e.g., Hamming or Reed-Solomon codes, as described in more detail below. A codeword in a Reed-Solomon code may be used as a secret share in the known Shamir secret-sharing scheme. For simplicity, an embodiment is described below that uses Shamir's secret shares, but any codewords from a linear error-correcting code could be used instead.

As a summary, Shamir's scheme builds on the observation that a polynomial of degree m≤n may be uniquely determined given the values of any set of at least n+1 distinct points that satisfy the polynomial expression. For example, knowledge of three distinct points that lie on a parabola is sufficient to completely determine the parabola. If more than n+1 distinct points are provided, however, then any set of n+1 of these may be used to determine the polynomial even if the other points remain secret. At the same time, knowledge of fewer than n+1 values will leave the polynomial undetermined and provide no more information than knowledge of no points at all, or random numbers.

More formally, let SS_{τ,s}(z) be the polynomial Σᵢ₌₁^{τ} α₁ zⁱ+m over group [symbol] as used in Shamir's secret sharing to generate secret shares for identifier z and secret m. Given τ+1 secret shares from the same polynomial SS_{τ,s}(z) one can reconstruct secret m, for example, efficiently using Lagrange interpolation, but r shares are indistinguishable from τ uniformly random numbers in [symbol] . Given n secret shares, where t=┌τ+(n−τ)/2┐ are from the same polynomial SS_{τ,s}(z) and └(n−τt)/2┘ are not, one can reconstruct z in polynomial time using Berlekamp-Welch's algorithm. (As is conventional, ┌.┐ and └.┘ represent the ceiling and floor functions, respectively.) It follows that n≥t>n/2 must hold. Other decoding algorithms for Reed-Solomon codes, such as list decoding, mentioned above, may also be used. For linear error-correcting codes other than Reed-Solomon codes, one must use the corresponding error-correcting recovery algorithm.

Now recall the condition in the definition of [symbol] *, that is, s (\vec{x}, \vec{y})>2t−n, as well as the expression t=┌τ+(n−τ)/2┐=┌½(τ+n)┐ relating to the Shamir secret shares shown above. In this embodiment, the threshold t may thus be determined as a function of τ+n.

Shamir's secret sharing is linear (as the error-correcting code is linear). Given secret shares σ=SS_{τ,s} (z) and σ′=SS_{τ,s′} (z), then σ+σ′=SS_{τ,s+s′} (z). Given τ secret shares from SS_{τ,s+s′} (z) one can reconstruct the sum of the corresponding secrets m+m′.

Now let [symbol] (α, β) be the equality function, i.e., [symbol] (α, β)=1 if α=β and 0 otherwise. The secure approximate equality operator may then implement the following similarity function s.

$$s ( \vec{x} , \vec{y} ) = {\sum }_{i = 1}^{n} ( {x}_{i} , {y}_{i} )$$

One way to define the secure approximate equality operator is as follows:
KeyGen (1^{λ}): Execute K←KeyGen_{MAC}(1^{λ}) and output K.
Encode (K, \vec{x}, t): Let m and m′be messages. Create n codewords from a linear code, e.g., Shamir's secret shares (SS) σᵢ for Reed-Solomon codes, σᵢ=SS_{2t-n,m} (i) and σ′ᵢ=SS_{2t-m,m′} (i) for 1≤i≤n. Output the vectors σ_{x,i}=σᵢ+MAC_{MACK(i)}(xᵢ) and σ′_{x,i}=σ′ᵢ−MAC_{MACK(i)}(xᵢ)
Compare (\vec{σ} _{\vec{x}}, \vec{σ} ′_{\vec{y}}): Compute ρᵢ=σ_{x,i}+σ′_{y,i}. Reconstruct m+m′ from ρᵢ.
   If the reconstruction is successful, output T and optionally m+m′, else ⊥.

Correctness: If xᵢ=yᵢ, then MAC_{MACK(i)}(xᵢ)=MAC_{MACK(i)}(yᵢ) and ρᵢ is a correct secret share on a polynomial SS_{2t-n,m+m′} (z). Hence, if at least t elements ρᵢ are correct secret shares, then reconstruction of m will be successful. However, if xᵢ@yᵢ then ρᵢ is uniformly distributed in [symbol] . If more than n−t elements ρᵢ are uniformly random, then reconstruction of m will be unsuccessful.

Relaxed Security: The leakage [symbol] *(\vec{x}, \vec{y}) is sufficient to simulate the secure approximate equality operator; here, the term “simulate” is used in the sense that there exists a simulation function Sim ( [symbol] *(\vec{x}, \vec{y})) that produces an output that an adversary cannot distinguish from a real execution, i.e., the defender simulates a real execution (without using the secret information). If at most 2t−n elements in the vector are equal, then at most 2t−n secret shares are on the polynomial SS_{2t-n,m+m′} (z) that are indistinguishable from uniform random numbers. Since the other elements are not equal, their secret shares are also indistinguishable from random numbers. Hence, the entire vector is indistinguishable from random numbers. If more than 2t−n elements in the vector are equal, then the reconstructor learns ρᵢ=σᵢ+σ′ᵢ+MAC_{MACK(i)}(xᵢ)−MAC_{MACK(i)}(yᵢ) and the recovery (for example, using Berlekamp-Welch's) algorithm also outputs σᵢ+σ′ᵢ. The leakage [symbol] *(\vec{x}, \vec{y}) includes MAC_{MACK(i)}(xᵢ)−MAC_{MACK(i)}(yᵢ). The secret share σᵢ+σ′ᵢ is identically distributed to a random secret share SS_{2t-n,m}(i).

The invention thus combines encryption of the original data sets \vec{x} and \vec{y} with a secret-sharing procedure. This enables the system to compare the data sets without revealing them, with partial revealing of information only when the data sets have been determined to be sufficiently similar.

### System Implementation

FIG. 1 shows a system for implementing the similarity/dissimilarity detection mechanism described formally above. As FIG. 1 shows, the system as a whole comprises a server 100, that is, a Service Provider or “comparison server”, and a number n of clients 200-1, . . . 200-n, each of which (including the server 100) comprises a physical and/or virtual computing system. In the most anticipated configuration, all or most of the clients will comprise a separate computing platform, although this is not strictly necessary—note that a single physical platform might host multiple instances of virtual machines, each of which could act as a client.

Both the server 100 and the clients include standard components such as system hardware with at least one processor, volatile and/or non-volatile memory and/or storage, standard I/O components as needed to enable communication with other entities and systems over any known type of network, wireless or wired. Some form of system software will also typically be included, such as an operating system and/or virtual machine hypervisor. Processor-executable code organized as software modules may be used to carry out the various computations and functions described below and may be stored and thus embodied in either or both types of memory/storage components. These software modules will thus comprise processor-executable code that, when run by the respective processor(s), cause the respective processor(s) to carry out the corresponding functions.

The client(s) and server communicate among themselves over any conventional wired or wireless network using a preferably secure and authenticated channel, one example of which is the known Transport Layer Security (TLS) cryptographic protocol.

In the case of multiple clients, in a key agreement phase, the clients communicate among each other to choose a common secret key. In a simple implementation, one client may choose the key and distribute it to the other clients.

Any known method may be used to choose which client is assigned/allowed the task of proposing a key. One method could be simply the first client to submit a key to the others.

Another method would be to choose the client whose identifier, for example, MAC or other address or identifier, when used as an input to an agreed upon randomizing function, produces an output that meets some selection criterion, such as being the lowest or highest or closest to some other value. If the set of clients is fixed, they could takes “turns” choosing the current key, following a predetermined order.

It would also be possible to allow multiple clients to choose the current key, including key agreement protocols, such as the well-known Diffie-Hellman scheme or its variants for multiple parties. Multiple keys might also arise in a first-to-propose scheme as a result of network delay. In such cases, any consensus mechanism may be implemented in order for the clients to come to agreement concerning which is to select the current key.

In still other systems, the clients may be subordinate to some administrative system, which itself chooses which client should select the current key, using any criteria the system designer chooses to implement. The server 100 could also be called upon to select which client is to choose the current key, although this might raise a concern about possible “collusion”.

After key agreement comes an analysis phase in which the clients send their encoded data to the server for similarity or dissimilarity detection. The security objective is that the server learns whether two events are similar or dissimilar but nothing else about the events encoded in the data.

In case similar events leak additional information, a fresh key can be chosen by the clients after at least one similar pair of events has been discovered by the server. This reduces the accumulated leakage of multiple similar pairs of events.

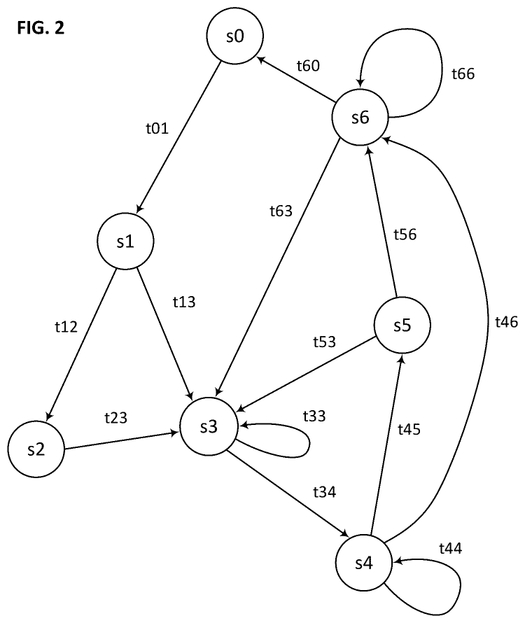

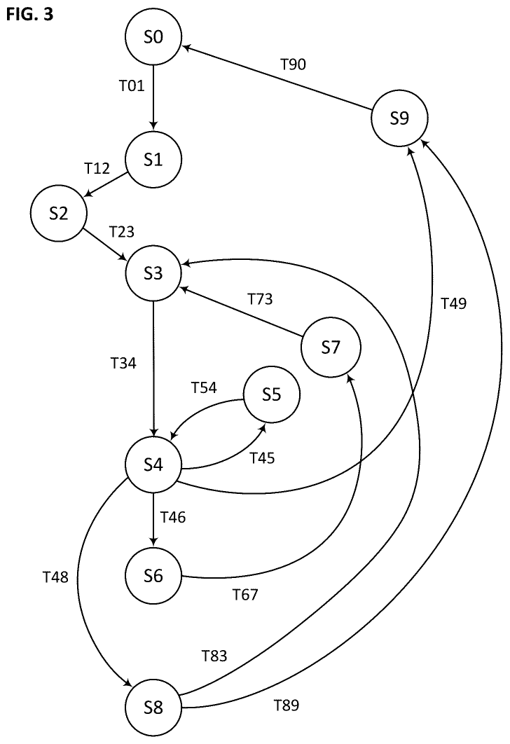

FIG. 2 and FIG. 3 are state diagrams that show the messages and state of a client Ci and the server 100, respectively, during this protocol:

In FIG. 2, “circles” indicate Client states s0-s6 and arrows labeled with the convention tij indicate transitions (and/or messages transmitted) from state i to state j; thus, for example, t23 indicates a transition from state s2 to state s3. State s simply indicates the state of a client at the beginning of a session.

Let m1-m8 indicate the following messages:
m1: ready for session, metadata for all clients, that is, the metadata that specifies all the clients that are to participate in the current session
m2: key exchange
m3: match, messageID of match, endFlag (default=0)
m4: End session
m5: end of records
m6: start key exchange protocol
m7: key exchange/derivation done
m8: send records

In states s1, s2, and s3, various operations are to be carried out:
s1: Send m1 to service provider
s2: Send m6 to other client(s)
s3: Execute key exchange/derivation and send m7. Key exchange is performed when the previous state is s1 or s2; key derivation otherwise.

The state transition conditions and actions of the client in this example are as follows:
t01: When the client has a record to match
t12: m2 received
t13: m6 received
t23: null
t33: m3 received. The loop is required because the keys need to be derived even for clients that are not yet participating in the matching, when there is a match, so that the key remains updated
t34: m8 received
t44 send record
t45: m3 received
t46 Send last record along with m5
t53 The client has a record to match
t56 No more records
t60: m4 received
t63: m3 received
t66: m3 received, endFlag==1

FIG. 2 depicts states Sx (x=0−6) and state transitions of the Service Provider in one prototype embodiment, where S0 is the initial state and, following the previous convention, Tij indicates a transition from state i to state j. Let n be the total number of participating clients, as specified in ml metadata and Ck indicate client k.

The state transition conditions and in-state actions of the client in this example are as follows:
T01: m1 received from all clients
T12: Send m2 to C1
T23: null
S3: Set i:=i+1 and send m8 to C1, . . . , Ci
T34: C1 to C (i−1)'s m5 received
S4: Listen for records and perform matching
T45: Matching is done; m5 is received from Ci; i<n
T46: Match occurs; C1 to C (i−1) have been iterated
T48: Match occurs on the last record, C1 to C (i−1) have all been iterated
T49: Matching is done and m5 is received from Cn
S6: Send m3 to all clients discard all received records.
S8: Set m3 to endFlag=1; send m3 to clients; discard all received records. As an alternative, this step may of generating and sending m3, and discarding records, may comprise waiting until some predetermined number or percentage of matching pairs have been accumulated
T67: Null
S7: i:=i−1 Note that this decrements i, which is then incremented in S2. This is because i should not be changed in S2 when m5 has not been received
T83: i<n
T89: i=n, that is, m5 was received from Cn
T90: End of session

The server 100 can collect metadata about the encoded data, for example, source client, arrival time, etc. This information can be used in decisions about events comprised of multiple similar encoded data, for example, clusters.

Application areas where detection of similar or dissimilar data is necessary include but are not limited to private record linkage (PRL) or private anomaly detection (PAD) (e.g., of cybersecurity events). As mentioned above, however, the invention may be used in many other fields as well. The action(s) the clients—or any other concerned entity—chooses to take in Determination of to the server's determination of similarity/dissimilarity will be equally varied. A determination of similarity/dissimilarity to at least the specified degree will, for example, have different interpretations in different use cases. In some cases a remedial action may be taken, such as granting or removing authorization for the clients to access or do something.

In PRL two or more parties have databases or portions of databases about the same entities (e.g., persons visiting a hospital). The records for the same entity are similar but may differ in the exact data, for example, due to data entry errors or format differences—Bob C.

Parker and Bob Parker may refer to the same entity—and the schema. The goal of PRL is to identify similar entities but not reveal anything about dissimilar entities. The invention is well-suited to performing PRL.

In PAD, two or more parties have a stream of events, some of which are dissimilar to the clients' normal behavior but similar among clients. This might, for example, be system events resulting from a (concerted) cybersecurity attack on multiple clients. The goal would then be to identify similar events across clients and report them as a cluster. An example cybersecurity attack could be credential stuffing attacks where attackers attempt the same username/password pair across multiple clients.

Before comparing data for similarity or dissimilarity, as mentioned above, the data is preferably encoded into fixed-length vectors. The distance metric used for similarity or dissimilarity detection may be known at encoding time; any conventional distance metric may be used, some of which are mentioned above.

Encoding may be performed using machine learning (ML). In ML there is a training phase and an inference phase. Data from an expected distribution, that is, training data, should be known. Using this data, a ML model may be trained in any known manner, such as a neural network being trained using contrastive learning.

In case of anomaly detection, a further preprocessing step may be applied. First, an encoder-decoder network may be trained using the normal data. This network is then fed normal and previous anomalous events. Anomalous events not used during the training will tend to have a high decoder reconstruction error, which may be used as the training data for a subsequent ML model trained using contrastive learning as before. During operation of the system, the inference of the ML used. The clients' data will then be fed into the model (including the encoder-decoder network for anomalous events). The output is the encoding that will be protected by the key and sent to the server.

Biometrics over Encrypted Data

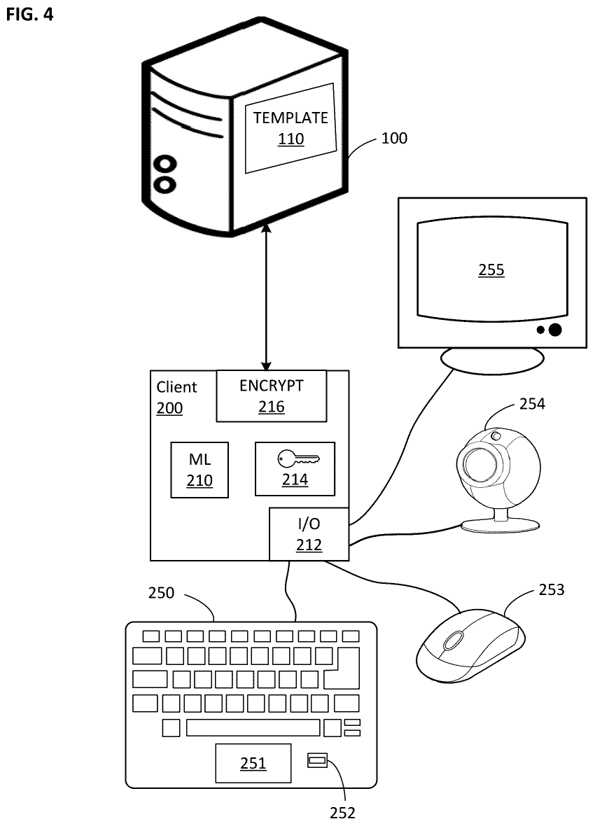

FIG. 4 illustrates the main components of an embodiment of the system in which the comparison method described above is applied to events that incorporate biometric data. This embodiment can be used to increase the robustness and security of authentication, for example, to control access to any form of logical or physical resource for which user authentication is carried out using a computer. As above, the system includes the server 100 and a client. In the illustrated case, only one client 200 is shown since authentication will typically be per-user and thus per-client.

In this embodiment, the client loads a machine learning model 210 from the server 100. The machine learning model, which is implemented as a software module running in the client, takes as input at least one biometric parameter, which may behavioral or physical or both. Behavioral biometrics will in general correspond to interactions the user has with peripheral devices that generate inputs to the client computing platform's I/O subsystem 212.

Just some of the examples of such behavioral biometric parameters include keystrokes on a keyboard 250, movements on a trackpad 251 or of a mouse 253, etc. Other types of behavioral biometric parameters could include information about how the user interacts with the software, for example, which applications or web sites the user has open or is viewing on a display 255, which displayed items (such as icons or tabs) the user clicks on, etc. The system could also monitor user activity and accumulate behavioral data even before the user begins the process of requesting authorization. For example, the user might typically choose to request access to a protected resource (including the client computer 200 itself) such as a database or service only after a preceding time-out period, or right after accessing some other non-protected resource (for example, an application or web site)

The interactions that are sensed and encoded need not be restricted to their actual nominal inputs. In other words, the behavioral information that is encoded for, for example, the keyboard, need not be restricted to just the sequence of keys the user presses, although that is an option, but rather such information as typing speed, typing rhythm, characteristic typing mistakes such as repeated deletion and replacement of certain keystroke patterns (which may be determined using known methods and stored in the client system), etc., may also be encoded as behavioral biometric information.

Physical biometric information could include, as just some examples, the user's fingerprint as captured by a sensor 252, touch, direction of the device), a voice sample or facial image as captured by a microphone/camera 254, and iris or retinal scan, etc.

Whether behavioral or physical, the biometric information input from whichever devices the system designer chooses to use may be converted into respective digital representations using known methods. The machine learning model 210, however, then encodes the chosen biometric information into a fixed length, user-specific vector representation as described above.

The machine learning model 210 is preferably trained using contrastive learning such as is described in, for example, Chen et al., “A Simple Framework for Contrastive Learning of Visual Representations”, arXiv: 2002.05709, Cornell University 2020.

The preferred machine learning model for behavioral biometrics used to implement this embodiment is a convolutional neural network (CNN). Input features, such as the time intervals between consecutive key presses, mouse movements, or others mentioned above form a unique pattern for each user. Local, short-term patterns are critical for identifying a user. A CNN is particularly effective in capturing these local features, since it uses a sliding window over the sequence which allows it to focus on (small) groups of consecutive input behavior. Moreover, CNNs have the advantageous property that they can efficiently learn from raw data without requiring manual feature engineering or preprocessing.

Two modes of operation may be implemented for the client: one-time and continuous. In one-time authentication, the biometric information is captured once. In continuous authentication, the biometric is captured continuously and updates are sent in regular or irregular intervals. A regular interval may be, for example, every x seconds, at one or more specified clock times every day, etc. Examples of irregular intervals include once a new input or has occurred, or when a specified input or type of input occurs.

In addition to capturing a biometric, the client also enters a secret such as a password, which is converted into a symmetric cryptographic key by a corresponding software module 214. The conversion may be done using any known method, such as the PKCS #5 version in the RSA Laboratories' Public-Key Cryptography Standards (PKCS) series. The resulting cryptographic key is stored in the client's memory for continuous authentication.

An encryption routine 216 in the client 200 then encrypts the fixed-length, user-specific encoding of the biometric using the cryptographic key derived from the user-entered secret (such as a password) and sends the encrypted biometric sample as a candidate vector to the server. In other words, the password that the user enters is used to generate the key that encrypts the biometric data that also is derived from the user. One advantage of the use of a secret such as a password to generate the cryptographic key is that it is repeatable: the user will presumably enter the password the same each time. On the other hand, as mentioned in the Background section above, a fixed password has relatively low entropy. By using it to generate a key that in turn is used to encrypt non-constant biometric information, however, entropy and thus security are greatly increased.

Note that, in this embodiment, there is only one client, so the client will not need to agree on a key with any other client; rather, the key is derived from the user-entered secret. The single client still creates secret shares as before, however, one for each element of the candidate vector in which the biometric information is embedded.

The server stores a biometric template 110, which comprises an encryption of typical biometrics for user(s) for a specific threshold. The entries of the template will preferably be in the same fixed-length vector form as the submission from the client. Instead of comparing fixed-length vectors from different clients, in this embodiment the system compares the vector submitted by the client's computing platform—the “candidate vector”—with the “template vector” corresponding to the user.

For authentication of a given user, the server inputs from the respective client the respective user identifier, the encrypted biometric sample and any optional device information. The server then compares the encrypted biometric sample with the encrypted biometric template using the methods described above to evaluate similarity. If the comparison routine Compare determines that the received, encrypted biometric sample, is similar enough to the corresponding template, then it may take any appropriate action, such as granting an implicit or explicit user request that corresponds to the authentication procedure. Such a request may be to access a resource, such as a file, database, web site, communication channel, etc., or to cause the server or some other platform with which the server communicates to perform some requested procedure or other action, etc. If the comparison routine finds too great dissimilarity, however, then any chosen action may be taken, such as denying the request, issuing a notification to a system administrator, etc.

A CNN is particularly advantageous for processing biometric data in that it uses contrastive learning: By mapping regions of inputs to corresponding regions of outputs, a CNN ensures that different behavior will lead to different outcomes, whereas similar behavior will lead to similar outcomes and identical behavior will lead to identical output.

In most implementations of this invention, the server will need to authenticate more than one user, and usually many users. A CNN as in the preferred embodiment is well suited for such a scenario in that, as it learns, it will create a distinct region in output space for each user. This enables efficient determination of similarity by the comparison routine Compare.

In some cases, biometric templates may be predetermined through pre-capture and stored in the server. In the simplest case, the client may capture multiple sets of the chosen biometrics, determine an average and a threshold, and send an encrypted template to the server using the cryptographic determined at the client. In other, more general cases, the server may learn the biometric template in a learning phase, in which the client sends biometric samples to the server. These samples may then be encrypted using any chosen, known symmetric encryption technology such as the scheme according to the Advanced Encryption Standard (AES). Once the client has collected and stored sufficiently many biometric samples to compute a template, the client may download all samples, compute the template and upload it to the server.

As in the multi-client embodiments described above, one advantage of this “biometric embodiment” is that raw biometric data about the user does not need to be leaked to the server 100 or to any other entity. As such, the server need not be (but could be) the same one that the user is interacting with otherwise, but rather could be a server or remote service that provides authentication to whichever server the user is attempting to access to retrieve data, to run an application, to open a web page, etc. In other words, the authentication method disclosed here may be provided as a remote authentication service to an enterprise or even to individual computing systems.

1. A method for biometric authentication of a user of a client computing platform comprising:
in a service-providing system:
inputting from the client computing platform a candidate vector comprising an encoded, ordered data set that is encrypted using a key generated from a secret entered by the user in the client computing platform, said ordered data set being a digital representation of at least one biometric parameter of the user, in which elements of the candidate vector are encrypted as secret shares based on the key;
determining a comparison value from a reconstruction of the secret shares according to a comparison function between the candidate vector and a template vector stored in the service-providing system;
when the comparison value meets a predetermined criterion, generating an authentication message indicating sufficient similarity between the candidate and template vectors;
whereby the service providing system determines a degree of similarity between the candidate and template vectors without requiring knowledge of raw data about the secret or the at least one biometric parameter.

2. The method of claim 1, further comprising evaluating an approximate equality function having, as input, the candidate and template vectors, elements of said vectors being integers, by evaluating a similarity function between the vectors, comparing the similarity function to a threshold value, and outputting a value representing at least approximate equality only when the similarity function has a predetermined relationship to the threshold.

3. The method of claim 2, further comprising evaluating the approximate equality function in a relaxed mode, in which information about the inputted candidate vector is leaked only when the approximate equality function indicates equality

4. The method of claim 2, in which the step of determining the comparison value comprises clustering elements in the candidate vector by evaluating the approximate equality function and determining anomalies based on cluster features.

5. The method of claim 2, in which the candidate and template vectors are encoded from n codewords, each of which forms a respective message, of a linear code as a function of a message authentication code (MAC) keyed using the key.

6. The method of claim 5, in which the n codewords are Shamir secret shares of a Reed-Solomon code and the vectors are encoded as the sum of respective ones of the secret shares and the message authentication code, further comprising attempting determination of the comparison value as a function of a sum of the messages and indicating equality when the reconstruction is successful.

7. The method of claim 1, in which the vectors are encoded using a linear error-correcting code.

8. The method of claim 7, in which the vectors are encoded using Shamir secret sharing.

9. The method of claim 1, in which the predetermined criterion is that more than a minimum number of ordered element pairs in pairs of the candidate and template vectors are identical.

10. The method of claim 9, in which the minimum number is 2t−n, where t is a selectable threshold value and n is the number of elements in each of the candidate and template vectors.

11. The method of claim 1, further comprising determining the comparison value by applying list decoding.

12. The method of claim 1, in which the at least one biometric parameter is behavioral and corresponds to user interaction with at least one device.

13. The method of claim 12, in which the user interaction comprises at least one of: motion of or on an input device, key sequence of typing on a keyboard, rhythm of typing on the keyboard, characteristic typing mistakes, selection of items displayed on a display, selection of applications to run and selection of web sites to view.

14. The method of claim 12, in which the behavioral biometric is physical and comprises at least one of the user's fingerprint, the user's voice and the user's facial image.

15. A method for biometric authentication of a user of a client computing platform comprising:
in a service-providing system:
inputting from the client computing platform a candidate vector comprising an encoded, ordered data set that is encrypted using a key generated from a secret entered by the user in the client computing platform, said ordered data set being a digital representation of at least one biometric parameter of the user, in which elements of the candidate vector are encrypted as secret shares based on the key;
determining a comparison value from a reconstruction of the secret shares according to a comparison function between the candidate vector and a template vector stored in the service-providing system;
evaluating an approximate equality function having, as input, the candidate and template vectors, elements of said vectors being integers, by evaluating a similarity function between the vectors, comparing the similarity function to a threshold value, and outputting a value representing at least approximate equality only when the similarity function has a predetermined relationship to the threshold;
when the comparison value meets a predetermined criterion, generating an authentication message indicating sufficient similarity between the candidate and template vectors;
in which:
the predetermined criterion is that more than a minimum number of ordered element pairs in pairs of the candidate and template vectors are identical;
the at least one biometric parameter is at least one of:
a behavioral parameter that corresponds to user interaction with at least one device, said use interaction comprising at least one of motion of an input device, user motion in contact with the input device, key sequence of typing on a keyboard, rhythm of typing on the keyboard, characteristic typing mistakes of the user, selection of items displayed on a display, and selection of applications to run and selection of web sites to view, and
a physical parameter that corresponds to at least one of the user's fingerprint, the user's voice and the user's facial image;
whereby the service providing system determines a degree of similarity between the candidate and template vectors without requiring knowledge of raw data about the secret or the at least one biometric parameter.

16. A method for biometric authentication of a user of a client computing platform comprising:
sensing and inputting at least one biometric parameter of the user;
creating a candidate vector by encrypting an encoded, ordered data set using a key generated from a secret entered by the user in the client computing platform, said ordered data set being a digital representation of the at least one biometric parameter of the user, in which elements of the candidate vector are encrypted as secret shares based on the key;
transmitting the candidate vector to a service-providing system that determines a comparison value from a reconstruction of the secret shares according to a comparison function between the candidate vector and a template vector stored in the service-providing system and when the comparison value meets a predetermined criterion, generates an authentication message indicating sufficient similarity between the candidate and template vectors, said authentication message corresponding to granting a user request;
whereby the service providing system determines a degree of similarity between the candidate and template vectors without requiring knowledge of raw data about the secret or the at least one biometric parameter.

17. The method of claim 16, in which the predetermined criterion is that more than a minimum number of ordered element pairs in pairs of the candidate and template vectors are identical.

18. The method of claim 16, in which the at least one biometric parameter is behavioral and corresponds to user interaction with at least one device, in which the user interaction comprises at least one of: motion of or on an input device, key sequence of typing on a keyboard, rhythm of typing on the keyboard, characteristic typing mistakes, selection of items displayed on a display, selection of applications to run and selection of web sites to view.

19. The method of claim 16, in which the behavioral biometric is physical and comprises at least one of the user's fingerprint, the user's voice and the user's facial image.

20. The method of claim 16, in which the user request is at one of request for access to a resource and request for the service-providing system to perform a procedure.
